(19) United States
(12) Patent Application Publication
(10) Pub. No.: US 2024/0298224 A1
(43) Pub. Date: Sep. 5, 2024

(54) ENHANCEMENTS TO CBRA AND CFRA L1/L2 TRIGGERED MOBILITY

(71) Applicants: RAKUTEN SYMPHONY INDIA PRIVATE LIMITED, INDORE, MP (IN); RAKUTEN MOBILE USA LLC, SAN MATEO, CA (US)

(72) Inventor: Subramanya CHANDRASHEKAR, INDORE (IN)

(73) Assignees: RAKUTEN SYMPHONY INDIA PRIVATE LIMITED, INDORE, MP (IN); RAKUTEN MOBILE USA LLC, SAN MATEO, CA (US)

(21) Appl. No.: 18/026,852

(22) PCT Filed: Feb. 22, 2023
(86) PCT No.: PCT/US2023/013611

§ 371 Date: Mar. 17, 2023

(51) Int. Cl. H04W 36/00; H04W 36/08

(52) U.S. Cl. CPC H04W 36/0072; H04W 36/08

(57) ABSTRACT

Provided are a method and system for handling L1/L2 triggered mobility (LTM) to reduce mobile latency. The method may include: transmitting, by a serving distributed unit (DU) to a user equipment (UE), a request to perform an uplink sync with a target cell of a target distributed unit (DU), wherein the UE performs the uplink sync with the target DU including transmitting a preamble signal to the target DU upon receiving the request, wherein the target DU determines a best beam group (BG) for the UE upon receiving the preamble signal; receiving, by the serving DU, a Random Access Channel (RACH) preamble based on the best BG, wherein the RACH preamble originates from the target DU; and executing, by the serving DU, a serving cell change (SCC) for the UE to one of a prepared target cell based on the RACH preamble.

### CROSS-REFERENCE TO RELATED APPLICATION

This application claims priority from Indian provisional application IN202221062661 filed on Nov. 2, 2022 in the Indian Patent Office, the entire disclosure of which is incorporated herein by reference for all purposes.

### BACKGROUND

### 1. Field

Systems and methods consistent with example embodiments of the present disclosure relate to L1/L2 triggered inter-cell changes in disaggregated telecommunications architecture.

### 2. Description of Related Art

A radio access network (RAN) is an important component in a telecommunications system, as it connects end-user devices (or user equipment (UE)) to other parts of the network. The RAN includes a combination of various network elements (NEs) that connect the end-user devices to a core network. Traditionally, hardware and/or software of a particular RAN is vendor specific.

Recently, the evolution of telco technologies enables many telco services to be realized virtually, in the form of software. For instance, RANs such as Open RAN (O-RAN) architectures, disaggregate one network component into multiple functional elements. By way of example, a baseband unit (BBU) or base station (i.e., eNB or gNB) is disaggregated into a number of functional elements including a distributed unit (DU) and a centralized unit (CU), wherein the CU can be further disaggregated into Centralized Unit-Control Plane (CU-CP) and Centralized Unit-User Plane (CU-UP). The disaggregation of network elements enables the telco services and the associated functions to be defined and provided in software-based form or virtual network services, such as Virtualized Network Functions (VNFs), Cloud-native Network Functions (CNFs) or Software Defined Networking (SDN), among others.

FIG. 1 illustrates a related art disaggregated gNB architecture in 3GPP. The gNB is disaggregated into multiple logical entities. Two gNB-DU nodes are illustrated, but it can be understood that multiple gNB-DU nodes may be present. It should also be noted that a single DU may host multiple cells. The gNB-DU nodes may communicate with the CU-CP via an F1-C interface, and with the CU-UP via an F1-U interface. The CU-CP and CU-UP may communicate via an E1 interface. The gNB-CU-CP hosts the Packet Data Convergence Protocol (PDCP) and Radio Resource Control (RRC) layers, while the gNB-DU hosts the Radio Link Control (RLC), Medium Access Control (MAC) and Physical (PHY) layers. The scheduling operation takes place at the gNB-DU.

In order to support an L1/L2 centric inter-cell change, since the RLC MAC and PHY layers are located in the gNB-DU, configuration of the cell change should be performed at the gNB-CU-CP whereas the serving cell change should be performed autonomously by the gNB-DU without further interaction with the upper layers. This operation may be referred to herein as L1/L2 triggered mobility (LTM).

The L1/L2-Triggered Mobility (LTM) is a mobility procedure that allows the network to switch the UE from a source cell to a target cell without necessarily requiring a reconfiguration with sync. In particular, the network, based L1 measurements received, can indicate in a L2 signalling (e.g., MAC CE) a beam belonging to a LTM candidate cell to which the UE should perform the LTM cell switch procedure. The UE is provided with at least one (or more) LTM candidate cell configuration(s) by the network before the execution of a LTM cell switch procedure.

In the related art, a possible first issue with LTM is that a LTM target cell is prepared for Contention Based Random Access (CBRA) (i.e., this configuration may be a result of there being a lack of Random Access Channel (RACH) preamble resources at the target cell). However, during the lead time (between LLM preparation and execution) the resource situation at the target cell (target DU) changes, such that the UE must perform CBRA even if the resource situation at the target cell has changed since the time of handover (HO) preparation. It is sub-optimal to perform CBRA again in this situation. This issue may be referred to as “Scenario 1” herein below.

A possible second issue with LTM in the related art is that a LTM target cell configuration is prepared for Contention Free Random Access (CFRA) mapped to a given beam group (BG), but the UE undergoes mobility during the lead time, which will leave allocated RACH preamble/resources at the target DU sub-optimal. This issue may be referred to as “Scenario 2” herein below.

FIG. 2 illustrates a typical deployment scenario in the related art where a CU-CP serves multiple DU's. A UE may be at position's A and B in gNB-DU1 in beam group 1 (BG1). At position A, LTM target cell was prepared in the target gNB-DU2. The best radio connection/conditions for position A would be beam group 2 (BG2) in target gNB-DU2. Referring back to Scenario 1, there would be no RACH preamble allocated to the UE in this case, since the load is not permitting. Referring back to Scenario 2, a RACH preamble corresponding to BG2 would be reserved and sent to the UE in the target cell configuration (i.e., by means of RRC reconfiguration message).

The UE may move to position B in gNB-DU1 when the LTM serving cell change (SCC) is sent to the UE from the serving DU. This would cause the best beam group to no longer be BG2, but rather be beam group 3 (BG3). Accordingly, as mentioned with reference to Scenario 1, this would cause the UE to have to perform Contention Based RACH Access (CBRA), even though the resource situation at the target cell has now changed since the time of HO preparation. This is sub-optimal. With reference to Scenario 2, since there is UE mobility between LTM preparation and execution, the RACH preamble allocated during preparation will become sub-optimal. There may be an immediate subsequent serving cell change (SCC) or Radio Link Failure (RLF), since the resources at the target cell are not reserved for BG3.

FIG. 3 illustrates a typical SCC/handover procedure performed in the related art using CBRA, where no issues occur. A UE may be configured for lower layer mobility/LTM with one or more target cells in one or more DU's. RRC (L3) measurements may be performed being sent form the UE to the CU-CP. The CU-CP may communicate with the target cell (target DU) using an F1: UE context setup procedure. The target DU may determine that no RACH preamble is available, and accordingly indicate to the CU-CP that CBRA configuration has been prepared and should be used by the UE. The CU-CP may accordingly send the the LTM target cell configuration, by using RRC reconfiguration to the UE. The UE may then perform an L1 intra-frequency measurement report and send this to the serving DU. Simultaneously, the target cell (target DU) may determine that the resource condition at the target cell has changed to “available”. Upon receiving the L1 measurement report, the serving DU may determine that the target cell radio condition is satisfied, and according instruct to perform the HO. Accordingly, the SCC may be executed using CBRA. This is sub-optimal since the resource condition at the target cell has changed and still the UE is not configured Contention-less RACH Access (CFRA) and is forced to perform CBRA.

FIG. 4 illustrates a SCC/handover procedure performed in the related art, in relation to Scenario 2. Descriptions of similar operations with FIG. 3 may be redundant and are excluded for conciseness. After receiving the L1 measurement report, the serving DU may determine that the target cell radio condition is above the pre-defined threshold (i.e., the connection is sub-optimal), and instruct the UE to perform SCC. However, after performing the SCC, the target cell finds that the reserved preamble (sent during preparation) is sub-optimal, due to UE mobility (i.e., moving from position A to position B in FIG. 2 illustrated above). This can result in a subsequent SCC, or RLF as explained above.

FIG. 5 illustrates a SCC/handover procedure performed in the related art, which intends to solve Scenario 2. Again, descriptions of similar operations with FIGS. 3 and 4 may be redundant and are excluded for conciseness. After receiving the L1 measurement report, the serving DU may compare the UE reported BG/preamble (in view of the L1 measurement report) against the BG/preamble allocated during preparation from the CU end (which was received in an F1 message). If these are different, the serving DU may ask the CU for an updated preamble, which in turn has to be routed to the target DU. This can be done by initiating an F1 procedure so that the serving DU can receive a message from the target DU, via the CU, containing an updated RACH preamble for the best BG. However, this is too slow for LTM. Particularly, it would require many F1 messages between the serving DU to the target DU via the CU (this could cause latency of at least 20 ms) and the UE must wait to deliver the SCC command. This can then result in RLF as the UE may be moving and in general the solution illustrated in FIG. 5 may not be acceptable for the low latency requirement of LTM.

With respect to CBRA and Situation 1, there is a need to avoid UE retries for uplink sync (UL sync) if the UL sync fails, and especially to avoid the scenario where a CBRA is caused during LTM SCC. With respect to CFRA and Situation 2, there is a need to deliver a re-configured RACH preamble to the UE.

### SUMMARY

Example embodiments of the present disclosure provide a method and system for handling L1/L2 triggered mobility (LTM) to reduce mobile latency. Particularly, according to embodiments, during inter-cell mobility the preamble resource reservation at the target cell (target DU) is performed based on an uplink sync (UL sync) and not after a serving cell change (SCC) command is issued. Since the UL sync is performed substantially in advance of SCC, updating the random access channel (RACH) preamble will not consume any additional latency during handover (HO). Put in other terms, it will not keep the serving DU waiting to send the SCC command.

Accordingly, the embodiments of the present disclosure may provide a more optimal approach for handling LTM.

According to embodiments, a method for configuring inter-cell changes that may be performed by at least one processor may be provided. The method may include: transmitting, by a serving distributed unit (DU) to a user equipment (UE), a request to perform an uplink sync with a target cell of a target distributed unit (DU), wherein the UE performs the uplink sync with the target DU including transmitting a preamble signal to the target DU upon receiving the request, wherein the target DU determines a best beam group (BG) for the UE upon receiving the preamble signal; receiving, by the serving DU, a Random Access Channel (RACH) preamble based on the best BG, wherein the RACH preamble originates from the target DU; and executing, by the serving DU, a serving cell change (SCC) for the UE to one of a prepared target cell based on the RACH preamble.

The preamble signal used during the UL sync may include a contention based random access (CBRA) preamble, wherein the UE is configured to determine whether the uplink sync is successful or not, wherein based on a determination that the uplink sync is successful, the target DU is configured to determine that there is no preamble allocated to the UE during a handover (HO) preparation phase, and wherein based on a determination that there is no preamble allocated to the UE, the target DU may be configured to allocate a RACH preamble and send to the serving DU, to configure contention free random access (CFRA) for the UE with the best BG for the UE.

The preamble signal used during the UL sync may include a contention based random access (CBRA) preamble; the UE may be configured to determine whether the uplink sync is successful or not; and based on a determination that the uplink sync is not successful, the UE may be configured to prevent any further attempts of uplink sync.

The UE may be configured to determine whether the RACH preamble received from the serving DU has arrived at the UE or not prior to the serving DU executing the SCC, and wherein based on a determination that an RACH preamble has not arrived at the serving DU prior to executing the SCC, the UE is configured to perform CBRA during execution of the SCC by the serving DU.

The preamble signal may include a contention free random access (CFRA) preamble, wherein the target DU is configured to determine whether there is already a preamble allocated to the UE, wherein based on a determination that there is already a preamble allocated to the UE, the target DU is configured to determine whether the preamble allocated to the UE is associated with the best BG for the UE, and wherein based on a determination that the preamble allocated to the UE is not associated with the best BG for the UE, the target DU is configured to allocate the RACH preamble to be a new preamble associated with the best BG for the UE, and wherein the method further comprises: sending the newly allocated RACH preamble to the serving DU, wherein the sending to the serving DU is via a control unit (CU) or directly over a DU-DU interface.

The serving DU may execute the SCC for the UE by: transmitting, by the serving DU, a downlink MAC Control Element (DL MAC CE) which includes the RACH preamble received from the target DU to the UE.

The target DU may be configured to estimate a timing advance (TA) of the UE based on the preamble signal received from the UE, share it with the serving DU and wherein the DL MAC CE sent from serving DU to the UE includes the estimated TA.

According to embodiments, a method, performed by at least one processor, for configuring inter-cell changes may be provided. The method may include: receiving, by a serving distributed unit (DU), a Random Access Channel (RACH) preamble, wherein the RACH preamble originates from a target distributed unit (DU); and executing, by the serving DU, a serving cell change (SCC) for a user equipment (UE) to one of a prepared target cell based on the RACH preamble; wherein the (UE) is not configured to perform uplink sync by the serving DU and the UE is not configured with a CFRA RACH preamble by the target DU, wherein the target DU is configured to determine whether availability of a RACH resource is subject to change between target cell configuration preparation and execution of the serving cell change; and wherein based on a determination that the RACH resource has become available, the target DU is configured to allocate a RACH preamble and send the RACH preamble to the serving DU, to configure contention free random access (CFRA) for the UE with a best beam group (BG) for the UE.

According to embodiments, an apparatus for configuring inter-cell changes may be provided. The apparatus may include: at least one memory storing computer-executable instructions; and at least one processor configured to execute the computer-executable instructions to: transmit, by a serving distributed unit (DU) to a user equipment (UE), a request to perform an uplink sync with a target cell of a target distributed unit (DU), wherein the UE performs the uplink sync with the target DU including transmitting a preamble signal to the target DU upon receiving the request, wherein the target DU determines a best beam group (BG) for the UE upon receiving the preamble signal; receive, by the serving DU, a Random Access Channel (RACH) preamble based on the best BG, wherein the RACH preamble originates from the target DU; and execute, by the serving DU, a serving cell change (SCC) for the UE to one of a prepared target cell based on the RACH preamble.

According to embodiments, an apparatus for configuring inter-cell changes may be provided. The apparatus may include: at least one memory storing computer-executable instructions; and at least one processor configured to execute the computer-executable instructions to: receive, by a serving distributed unit (DU), a Random Access Channel (RACH) preamble, wherein the RACH preamble originates from a target distributed unit (DU); and execute, by the serving DU, a serving cell change (SCC) for a user equipment (UE) to one of a prepared target cell based on the RACH preamble; wherein the (UE) is not configured to perform uplink sync by the serving DU and the UE is not configured with a CFRA RACH preamble by the target DU, wherein the target DU is configured to determine whether availability of a RACH resource is subject to change between target cell configuration preparation and execution of the serving cell change; and wherein based on a determination that the RACH resource has become available, the target DU is configured to allocate a RACH preamble and send the RACH preamble to the serving DU, to configure contention free random access (CFRA) for the UE with a best beam group (BG) for the UE.

The RACH preamble may be received when a resource situation changes at the target DU. The SCC may include sending the RACH preamble to the UE via a downlink MAC Control Element (DL MAC CE). The target DU may be configured to estimate a timing advance (TA), and the DL MAC CE includes the estimated TA. The RACH preamble may be sent to the serving DU via a control unit (CU) or directly over a DU-DU interface.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a disaggregated gNB architecture according to the related art;

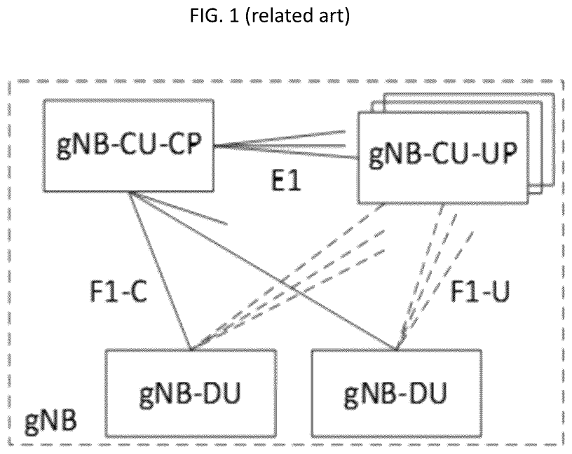

FIG. 2 illustrates a deployment diagram of gNB architecture according to the related art;

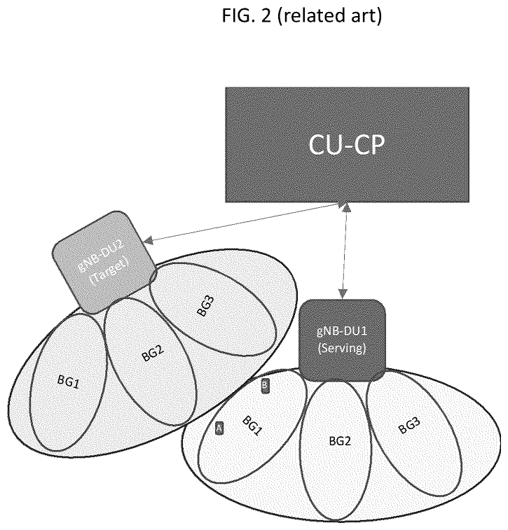

FIG. 3 illustrates a SCC/handover procedure performed in the related art using CBRA.

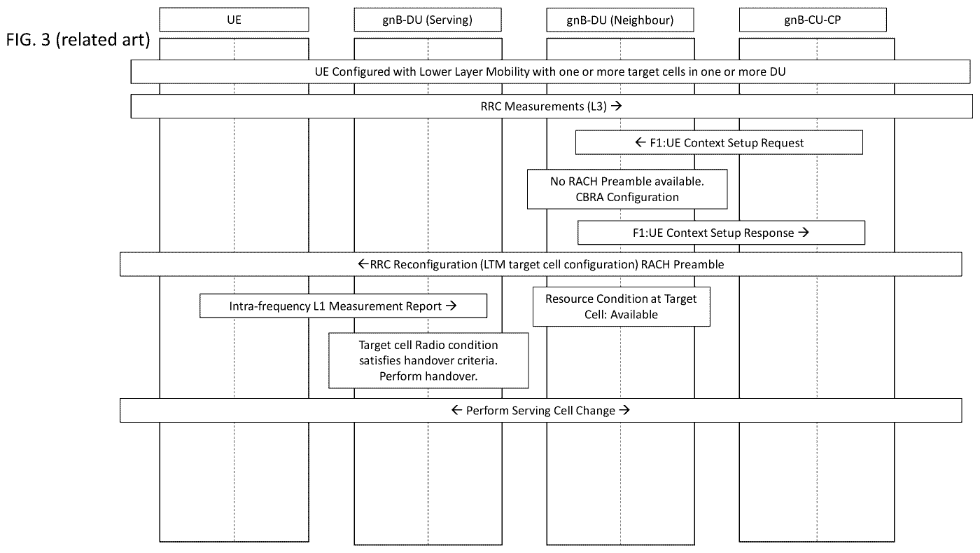

FIG. 4 illustrates a SCC/handover procedure performed in the related art in relation to Situation 2;

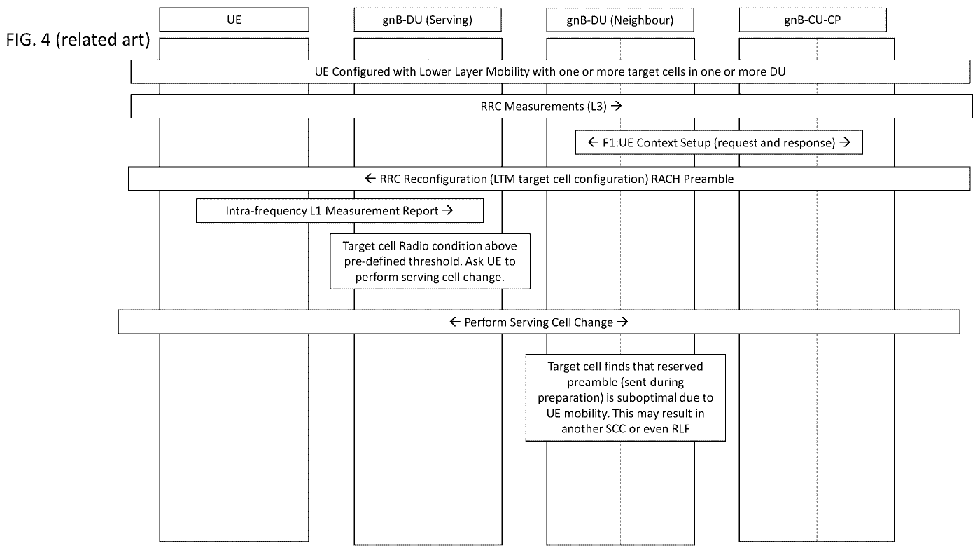

FIG. 5 illustrates another SCC/handover procedure performed in the related art in relation to Situation 2;

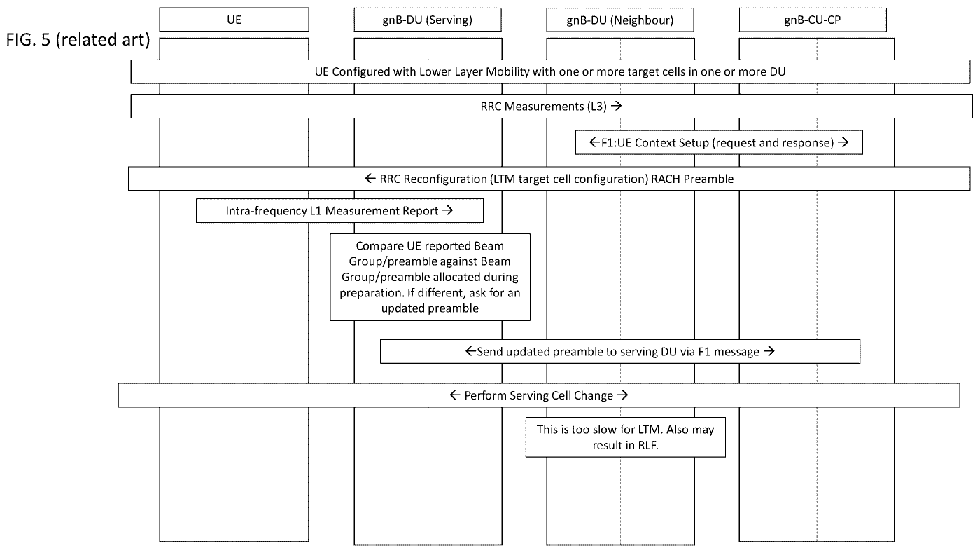

FIG. 6 illustrates a SCC/handover procedure for CFRA according to an embodiment;

FIG. 7 illustrates a SCC/handover procedure for CBRA according to an embodiment;

FIG. 8 is a diagram of an example environment in which systems and/or methods, described herein, may be implemented; and

FIG. 9 is a diagram of example components of a device according to an embodiment.

### DETAILED DESCRIPTION

The following detailed description of example embodiments refers to the accompanying drawings.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Example embodiments of the present disclosure provide a method and system for handling L1/L2 triggered mobility (LTM) to reduce mobile latency. Particularly, according to embodiments, during inter-cell mobility the preamble resource reservation at the target cell (target DU) is performed based on an uplink sync (UL sync) and not after a serving cell change (SCC) command is issued. Since the UL sync is performed substantially in advance of SCC, updating the random access channel (RACH) preamble will not consume any additional latency during handover (HO). Put in other terms, it will not keep the serving DU waiting to send the SCC command.

Accordingly, the embodiments of the present disclosure may provide a more optimal approach for handling LTM.

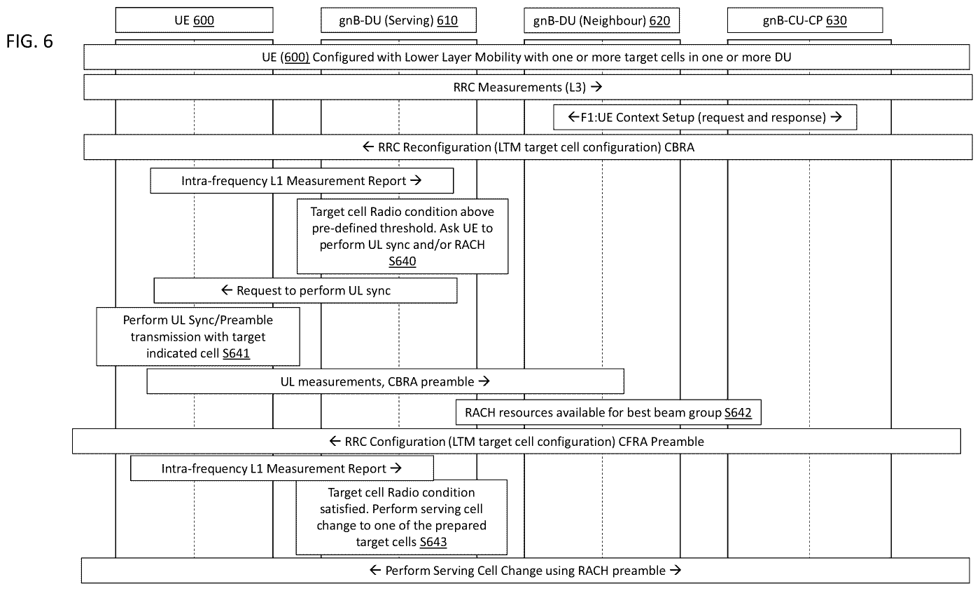

FIG. 6 illustrates an example timing diagram for a SCC/handover procedure using CBRA according to one or more embodiments. UE 600, Serving DU 610, Target DU 620, and CU-CP 630 may be provided. UE 600 may be configured with Lower Layer (L1/L2) triggered mobility (LTM) with one or more target cells in one or more DU's (e.g., target DU 620). UE 600 may initially provide RRC measurements (L3) to CU-CP 630. CU-CP 630 may perform a F1: UE context setup procedure by sending a request to the target DU 620, and receive a response therefrom. Subsequently, CU-CP 630 may send a RRC reconfiguration message to UE 600 to configure for LTM in the target cell (target DU 620) using CBRA. UE 600 may then send an intra-frequency L1 measurement report to the serving DU 610.

Referring still to FIG. 6, at operation S640, the serving DU 610 may detect that the target cell radio condition is above the pre-defined threshold. For example, this may be based on the L1 measurement report indicating that the UE 600 has poor radio connection with serving DU 620. Accordingly, serving DU 610 may instruct UE 600 to perform an uplink sync and/or RACH procedure with target DU 620.

At operation S641, after receiving the instruction to perform the uplink sync sent in operation S640, the UE 600 performs the uplink sync, which may include transmitting a preamble to the target DU 620. The UE 600 may send uplink measurements and a CBRA preamble to target DU 620.

At operation S642, after receiving the preamble signal from UE 600, the target DU 620 may determine the best beam group (BG), and that RACH resources are available for the best BG. Based on this determination, the CU-CP 630 may send the RACH preamble based on the best BG to serving DU 610 (e.g. via an F1:UE context modification procedure). CU-CP 630 may send another RRC configuration message to the UE 600 to configure LTM in the target cell (target DU 620) using CFRA. UE 600 may then once again send an intra-frequency L1 measurement report to the serving DU 610.

At operation S643, after receiving the intra-frequency L1 measurement report from UE 600, the serving DU 610 may detect that the target cell radio condition is now satisfied. Accordingly, the serving DU 610 may instruct UE 600 to execute SCC using the RACH preamble. The RACH preamble may be transmitted to the UE 600 using a downlink MAC control element (DL MAC CE) according to embodiments.

According to an embodiment, the UE 600 may be configured to determine whether the UL sync performed in operation S641 is successful or not. If it is successful, the target DU 620 may be configured to determine that there is no preamble allocated to UE 600 by the target DU. If it is determined that there is no preamble allocated to UE 600, then the target DU 620 may be configured to allocate the RACH preamble and send it to the serving DU 610 to configure CFRA for the UE 600 with the best BG for the UE 600.

According to an embodiment, UE 600 may determine that the UL sync performed in operation S641 is not successful, then UE 600 may be configured to stop any further attempts of uplink sync. UE 600 may then determine whether the RACH preamble received by serving DU 610 has arrived at the UE 600 or not, prior to the serving DU 610 executing the SCC in operation S643. If it is determined that the RACH preamble was not received prior to the serving DU 610 executing the SCC, then the UE may be configured to perform CBRA during execution of the SCC by the serving DU.

Based on the above embodiments, the preamble resource reservation is done based on the UL sync, and is prior to the SCC command being issued. Further, with reference to Situation 1, since UE 600 can detect when UL sync fails (for example, due to CBRA failure), and thereby specifically avoids any further UL sync, and only performs CBRA unless it is absolutely necessary. Thus, the above embodiments may achieve optimal LTM with low latency and avoid repeated CBRA unless it is absolutely necessary.

It should be noted that although the above embodiment is described including UL sync, other embodiments are not necessarily limited thereto. In particular, according to one embodiment, UE 600 may not be configured to perform an uplink sync, and UE 600 may not be configured with a CFRA RACH preamble by target DU 620. In this case, target DU 620 may be configured to determine whether the availability of a RACH resource is subject to change between the time of target cell configuration preparation and the execution of the SCC (i.e., in operation S643). Based on a determination that the RACH resource becomes available, target DU 620 may thereafter be configured to allocate a RACH preamble, and send the RACH preamble to serving DU 610 in order to configure CFRA for UE 600 with the best BG for UE 600.

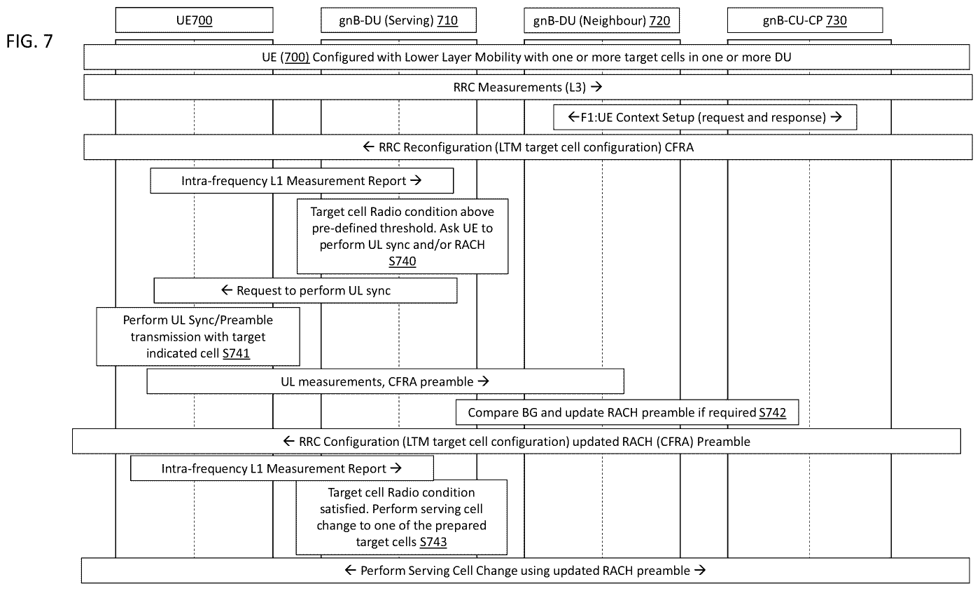

FIG. 7 illustrates an example timing diagram for a SCC/handover procedure using CFRA according to one or more embodiments.

UE 700, Serving DU 710, Target DU 720, and CU-CP 730 may be provided. It should be appreciated that these elements may be similar to UE 600, Serving DU 710, Target DU 720, and CU-CP 630 described in FIG. 6 above. UE 700 may be configured with Lower Layer (L1/L2) triggered mobility (LTM) with one or more target cells in one or more DU's (e.g., target DU 720). UE 700 may initially provide RRC measurements (L3) to CU-CP 730. CU-CP 730 may perform a F1:UE context setup procedure by sending a request to the target DU 720, and receive a response therefrom. Subsequently, CU-CP 730 may send a RRC reconfiguration message to UE 700 to configure for LTM in the target cell (target DU 720) using CFRA. UE 700 may then send an intra-frequency L1 measurement report to the serving DU 710.

Referring still to FIG. 7, at operation S740, the serving DU 710 may detect that the target cell radio condition is above the pre-defined threshold. For example, this may be based on the L1 measurement report indicating that the UE 700 has poor radio connection with serving DU 720. Accordingly, serving DU 710 may instruct UE 700 to perform an uplink sync and/or RACH procedure with target DU 720.

At operation S741, after receiving the instruction to perform the uplink sync sent in operation S740, the UE 700 performs the uplink sync, which may include transmitting a preamble to the target DU 720. The UE 700 may send uplink measurements and a CBRA preamble to target DU 720.

At operation S642, after receiving the preamble signal from UE 700, the target DU 720 may determine that there is a preamble already allocated to UE 700, and that this preamble is not associated with the best beam group (BG). This may be performed by comparing the BG associated with the preamble with the best BG. Based on this comparison, target DU 720 may determine that the RACH preamble should be updated, such that target DU 720 may allocate an updated RACH preamble to UE 700. Based on this determination, the CU-CP 730 may send an updated RACH preamble based on the best BG to serving DU 710 (via an F1:UE context modification procedure). According to some embodiments, the sending of the updated RACH preamble may also be executed over a DU-DU interface. CU-CP 730 may send another RRC configuration message to the UE 700 to configure for LTM in the target cell (target DU 720) using CFRA. UE 700 may then once again send an intra-frequency L1 measurement report to the serving DU 710.

At operation S743, after receiving the intra-frequency L1 measurement report from UE 700, the serving DU 710 may detect that the target cell radio condition is now satisfied. Accordingly, the serving DU 710 may instruct UE 600 to execute SCC using the RACH preamble. The RACH preamble may be transmitted to the UE 700 using a downlink MAC control element (DL MAC CE) according to embodiments.

Based on the above embodiments, the preamble resource reservation is done based on the UL sync, and is prior to the SCC command being issued. Further, with reference to Situation 2, even when the UE undergoes mobility, since target DU 720 compares UE 700's best BG against the one which UE 700 was initially prepared for, and proactively sends this to the serving DU 710, UE 700 execute the SCC using the best BG. Thus, the above embodiments may achieve optimal LTM with low latency even while undergoing UE mobility.

According to one embodiment, the target DU 620, 720 may be configured to estimate a timing advance (TA) of the UE 600, 700 based on the preamble signal received from UE 600, 700. The estimated TA may be indicated to the serving DU via the CU and by serving DU 610, 710 via the downlink MAC control element (DL MAC CE) to the UE. The indication may be sent to the UE 600, 700 within or together with the cell switch command or before the cell switch command. The estimated TA may be sent to the UE 600, 700 within a time interval after the preamble is transmitted by the UE 600, 700. The UE may monitor the PDCCH for the TA message within this time interval.

According to one embodiment, if the UE 600, 700 does not receive a TA message within the time interval during which the TA message is expected, the UE 600, 700 may resend the same preamble or another preamble. The maximum number of times the UE tries to send a preamble (same or different preambles) may be fixed and configured. The maximum number may be set to 1.

According to another embodiment, the UE 600, 700 may expect to receive the TA message within or together with the cell switch command message. In one case, the cell switch message may not contain a valid TA value (or a valid TA value may not be received within or outside the cell switch command), for example due to the unsuccessful reception of the preamble at the target cell (target DU 620, 720).

According to an embodiment, if the UE 600, 700 is not indicated a valid TA value (e.g., before, within, or together with the cell switch message), then the UE 600, 700 performs RACH in the target cell (target DU 620, 720). after it receives the cell switch message and executes the cell switch. This may be referred to as a fallback to the conventional RACH mechanism. For the RACH procedure, it may use the configuration indicated during LTM preparation. If the UE 600, 700 is indicated a valid TA value, it may adjust its transmission accordingly and start transmission to the target cell (target DU 620, 720). after the cell switch command is received and cell switch is performed.

According to an embodiment, the serving cell (serving DU 610, 710) may send to the UE 600, 700 a first TA value and an indication whether the UE 600, 700 shall perform another RACH after the cell switch command is executed. The additional RACH may be CFRA and resources for it may also be indicated in a DL MAC CE. This may be useful for example if the target cell (target DU 620, 720) is trying to improve the reliability of the calculated TA. The UE 600, 700 may use the first TA value to adjust its uplink timing when transmitting after the cell switch command is executed.

When the UE 600, 700 receives the TA value, it may start a timer. The timer may start at a predefined time, e.g., in the nth (e.g, n=1) slot after the slot that contains the message in which the TA value is transmitted. The timer may be in terms of seconds, milliseconds, slots, etc. If the cell switch command is not received by the time the timer expires, then the UE 600, 700 may perform RACH after the cell switch command is executed. This may mean that the indicated TA value is discarded. In another method, the TA value applicable in a specific cell may be valid for a predefined (e.g., configured, signaled) validity time and the UE 600, 700 may store and use the last updated TA value within the validity time.

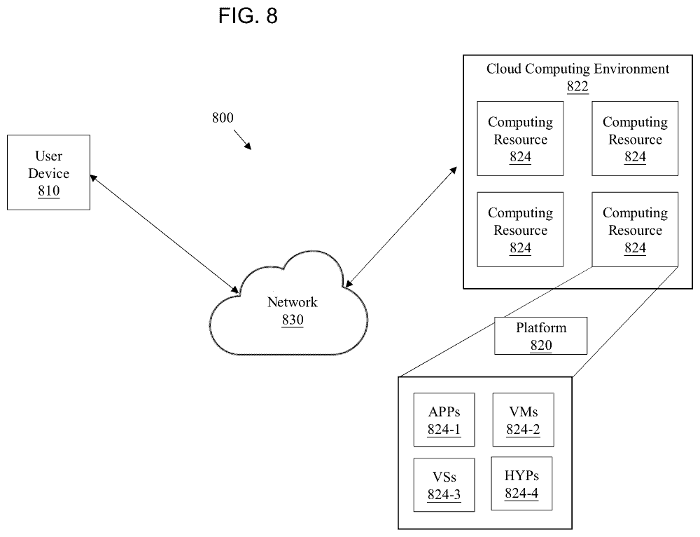

FIG. 8 is a diagram of an example environment 800 in which systems and/or methods, described herein, may be implemented. As shown in FIG. 8, environment 800 may include a user device 810, a platform 820, and a network 830. Devices of environment 800 may interconnect via wired connections, wireless connections, or a combination of wired and wireless connections. In embodiments, any of the functions and operations described with reference to FIGS. 6 through 7 above may be performed by any combination of elements illustrated in FIG. 8.

User device 810 includes one or more devices capable of receiving, generating, storing, processing, and/or providing information associated with platform 820. For example, user device 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 810 may receive information from and/or transmit information to platform 820.

Platform 820 includes one or more devices capable of receiving, generating, storing, processing, and/or providing information. In some implementations, platform 820 may include a cloud server or a group of cloud servers. In some implementations, platform 820 may be designed to be modular such that certain software components may be swapped in or out depending on a particular need. As such, platform 820 may be easily and/or quickly reconfigured for different uses.

In some implementations, as shown, platform 820 may be hosted in cloud computing environment 822. Notably, while implementations described herein describe platform 820 as being hosted in cloud computing environment 822, in some implementations, platform 820 may not be cloud-based (i.e., may be implemented outside of a cloud computing environment) or may be partially cloud-based.

Cloud computing environment 822 includes an environment that hosts platform 820. Cloud computing environment 822 may provide computation, software, data access, storage, etc., services that do not require end-user (e.g., user device 810) knowledge of a physical location and configuration of system(s) and/or device(s) that hosts platform 820. As shown, cloud computing environment 822 may include a group of computing resources 824 (referred to collectively as “computing resources 824” and individually as “computing resource 824”).

Computing resource 824 includes one or more personal computers, a cluster of computing devices, workstation computers, server devices, or other types of computation and/or communication devices. In some implementations, computing resource 824 may host platform 820. The cloud resources may include compute instances executing in computing resource 824, storage devices provided in computing resource 824, data transfer devices provided by computing resource 824, etc. In some implementations, computing resource 824 may communicate with other computing resources 824 via wired connections, wireless connections, or a combination of wired and wireless connections.

As further shown in FIG. 8, computing resource 824 includes a group of cloud resources, such as one or more applications (“APPs”) 824-1, one or more virtual machines (“VMs”) 824-2, virtualized storage (“VSs”) 824-3, one or more hypervisors (“HYPs”) 824-4, or the like.

Application 824-1 includes one or more software applications that may be provided to or accessed by user device 810. Application 824-1 may eliminate a need to install and execute the software applications on user device 810. For example, application 824-1 may include software associated with platform 820 and/or any other software capable of being provided via cloud computing environment 822. In some implementations, one application 824-1 may send/receive information to/from one or more other applications 824-1, via virtual machine 824-2.

Virtual machine 824-2 includes a software implementation of a machine (e.g., a computer) that executes programs like a physical machine. Virtual machine 824-2 may be either a system virtual machine or a process virtual machine, depending upon use and degree of correspondence to any real machine by virtual machine 824-2. A system virtual machine may provide a complete system platform that supports execution of a complete operating system (“OS”). A process virtual machine may execute a single program, and may support a single process. In some implementations, virtual machine 824-2 may execute on behalf of a user (e.g., user device 810), and may manage infrastructure of cloud computing environment 822, such as data management, synchronization, or long-duration data transfers.

Virtualized storage 824-3 includes one or more storage systems and/or one or more devices that use virtualization techniques within the storage systems or devices of computing resource 824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 824-4 may provide hardware virtualization techniques that allow multiple operating systems (e.g., “guest operating systems”) to execute concurrently on a host computer, such as computing resource 824. Hypervisor 824-4 may present a virtual operating platform to the guest operating systems, and may manage the execution of the guest operating systems. Multiple instances of a variety of operating systems may share virtualized hardware resources.

Network 830 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

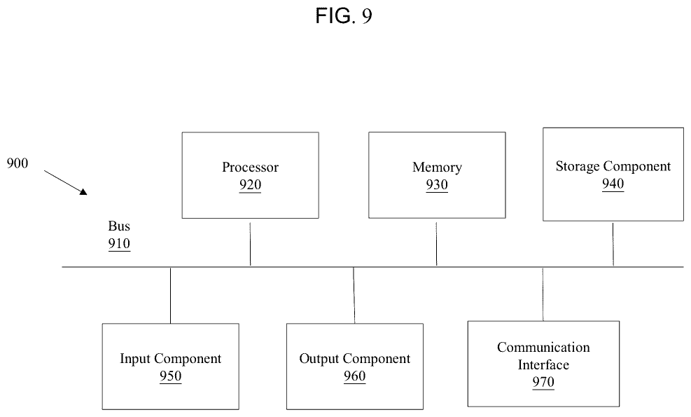

FIG. 9 is a diagram of example components of a device 900. Device 900 may correspond to user device 810 and/or platform 820. As shown in FIG. 9, device 900 may include a bus 910, a processor 920, a memory 930, a storage component 940, an input component 950, an output component 960, and a communication interface 970.

Bus 910 includes a component that permits communication among the components of device 900. Processor 920 may be implemented in hardware, firmware, or a combination of hardware and software. Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 includes one or more processors capable of being programmed to perform a function. Memory 930 includes a random access memory (RAM), a read only memory (ROM), and/or another type of dynamic or static storage device (e.g., a flash memory, a magnetic memory, and/or an optical memory) that stores information and/or instructions for use by processor 920.

Storage component 940 stores information and/or software related to the operation and use of device 900. For example, storage component 940 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 950 includes a component that permits device 900 to receive information, such as via user input (e.g., a touch screen display, a keyboard, a keypad, a mouse, a button, a switch, and/or a microphone). Additionally, or alternatively, input component 950 may include a sensor for sensing information (e.g., a global positioning system (GPS) component, an accelerometer, a gyroscope, and/or an actuator). Output component 960 includes a component that provides output information from device 900 (e.g., a display, a speaker, and/or one or more light-emitting diodes (LEDs)).

Communication interface 970 includes a transceiver-like component (e.g., a transceiver and/or a separate receiver and transmitter) that enables device 900 to communicate with other devices, such as via a wired connection, a wireless connection, or a combination of wired and wireless connections. Communication interface 970 may permit device 900 to receive information from another device and/or provide information to another device. For example, communication interface 970 may include an Ethernet interface, an optical interface, a coaxial interface, an infrared interface, a radio frequency (RF) interface, a universal serial bus (USB) interface, a Wi-Fi interface, a cellular network interface, or the like.

Device 900 may perform one or more processes described herein. Device 900 may perform these processes in response to processor 920 executing software instructions stored by a non-transitory computer-readable medium, such as memory 930 and/or storage component 940. A computer-readable medium is defined herein as a non-transitory memory device. A memory device includes memory space within a single physical storage device or memory space spread across multiple physical storage devices.

Software instructions may be read into memory 930 and/or storage component 940 from another computer-readable medium or from another device via communication interface 970. When executed, software instructions stored in memory 930 and/or storage component 940 may cause processor 920 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

In embodiments, any one of the operations or processes of FIGS. 6 through 7 may be implemented by or using any one of the elements illustrated in FIGS. 8 and 9. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

### Various Aspects of Embodiments

Various further respective aspects and features of embodiments of the present disclosure may be defined by the following items:

Item [1]: A method, performed by at least one processor, for configuring inter-cell changes, the method comprising: transmitting, by a serving distributed unit (DU) to a user equipment (UE), a request to perform an uplink sync with a target cell of a target distributed unit (DU), wherein the UE performs the uplink sync with the target DU including transmitting a preamble signal to the target DU upon receiving the request, wherein the target DU determines a best beam group (BG) for the UE upon receiving the preamble signal; receiving, by the serving DU, a Random Access Channel (RACH) preamble based on the best BG, wherein the RACH preamble originates from the target DU; and executing, by the serving DU, a serving cell change (SCC) for the UE to one of a prepared target cell based on the RACH preamble.

Item [2]: The method as claimed in item [1], wherein the preamble signal used during the UL sync includes a contention based random access (CBRA) preamble, wherein the UE is configured to determine whether the uplink sync is successful or not, wherein based on a determination that the uplink sync is successful, the target DU is configured to determine that there is no preamble allocated to the UE during a handover (HO) preparation phase, and wherein based on a determination that there is no preamble allocated to the UE, the target DU is configured to allocate a RACH preamble and send to the serving DU, to configure contention free random access (CFRA) for the UE with the best BG for the UE.

Item [3]:The method according to item [1], wherein: the preamble signal used during the UL sync includes a contention based random access (CBRA) preamble; the UE is configured to determine whether the uplink sync is successful or not; and based on a determination that the uplink sync is not successful, the UE is configured to prevent any further attempts of uplink sync.

Item [4]: The method according to item [4], wherein the UE is configured to determine whether the RACH preamble received from the serving DU has arrived at the UE or not prior to the serving DU executing the SCC, and wherein based on a determination that an RACH preamble has not arrived at the serving DU prior to executing the SCC, the UE is configured to perform CBRA during execution of the SCC by the serving DU.

Item [5]: The method according to Item [1], wherein the preamble signal includes a contention free random access (CFRA) preamble, wherein the target DU is configured to determine whether there is already a preamble allocated to the UE, wherein based on a determination that there is already a preamble allocated to the UE, the target DU is configured to determine whether the preamble allocated to the UE is associated with the best BG for the UE, and wherein based on a determination that the preamble allocated to the UE is not associated with the best BG for the UE, the target DU is configured to allocate the RACH preamble to be a new preamble associated with the best BG for the UE, and wherein the method further comprises: sending the newly allocated RACH preamble to the serving DU, wherein the sending to the serving DU is via a control unit (CU) or directly over a DU-DU interface.

Item [6]: The method according to item [1], wherein the serving DU executing the SCC for the UE further comprises: transmitting, by the serving DU, a downlink MAC Control Element (DL MAC CE) which includes the RACH preamble received from the target DU to the UE.

Item [7]: The method according to item [6], wherein the target DU is configured to estimate a timing advance (TA) of the UE based on the preamble signal received from the UE, wherein the DL MAC CE includes the estimated TA.

Item [8]: A method, performed by at least one processor, for configuring inter-cell changes, the method comprising: receiving, by a serving distributed unit (DU), a Random Access Channel (RACH) preamble, wherein the RACH preamble originates from a target distributed unit (DU); and executing, by the serving DU, a serving cell change (SCC) for a user equipment (UE) to one of a prepared target cell based on the RACH preamble; wherein the (UE) is not configured to perform uplink sync by the serving DU and the UE is not configured with a CFRA RACH preamble by the target DU, wherein the target DU is configured to determine whether availability of a RACH resource is subject to change between target cell configuration preparation and execution of the serving cell change; and wherein based on a determination that the RACH resource has become available, the target DU is configured to allocate a RACH preamble and send the RACH preamble to the serving DU, to configure contention free random access (CFRA) for the UE with a best beam group (BG) for the UE.

Item [9]. An apparatus for configuring inter-cell changes, the apparatus comprising: at least one memory storing computer-executable instructions; and at least one processor configured to execute the computer-executable instructions to: transmit, by a serving distributed unit (DU) to a user equipment (UE), a request to perform an uplink sync with a target cell of a target distributed unit (DU), wherein the UE performs the uplink sync with the target DU including transmitting a preamble signal to the target DU upon receiving the request, wherein the target DU determines a best beam group (BG) for the UE upon receiving the preamble signal; receive, by the serving DU, a Random Access Channel (RACH) preamble based on the best BG, wherein the RACH preamble originates from the target DU; and execute, by the serving DU, a serving cell change (SCC) for the UE to one of a prepared target cell based on the RACH preamble.

Item [10]. The apparatus according to item [9], wherein the preamble signal used during the UL sync includes a contention based random access (CBRA) preamble, wherein the UE is configured to determine whether the uplink sync is successful or not, wherein based on a determination that the uplink sync is successful, the target DU is configured to determine that there is no preamble allocated to the UE during a handover (HO) preparation phase, and wherein based on a determination that there is no preamble allocated to the UE, the target DU is configured to allocate a RACH preamble and send to the serving DU, to configure contention free random access (CFRA) for the UE with the best BG for the UE.

Item [11]. The apparatus according to item [9], wherein: the preamble signal used during the UL sync includes a contention based random access (CBRA) preamble; the UE is configured to determine whether the uplink sync is successful or not; and based on a determination that the uplink sync is not successful, the UE is configured to prevent any further attempts of uplink sync.

Item [12]. The apparatus according to item [11], wherein the UE is configured to determine whether the RACH preamble received from the serving DU has arrived at the UE or not prior to the serving DU executing the SCC, and wherein based on a determination that an RACH preamble has not arrived at the serving DU prior to executing the SCC, the UE is configured to perform CBRA during execution of the SCC by the serving DU.

Item [13]. The apparatus according to item [9], wherein the preamble signal includes a contention free random access (CFRA) preamble, wherein the target DU is configured to determine whether there is already a preamble allocated to the UE, wherein based on a determination that there is already a preamble allocated to the UE, the target DU is configured to determine whether the preamble allocated to the UE is associated with the best BG for the UE, and wherein based on a determination that the preamble allocated to the UE is not associated with the best BG for the UE, the target DU is configured to allocate the RACH preamble to be a new preamble associated with the best BG for the UE, and wherein the at least one processor is further configured to execute the computer-executable instructions to: send the newly allocated RACH preamble to the serving DU, wherein the sending to the serving DU is via a control unit (CU) or directly over a DU-DU interface.

Item [14]. The apparatus according to item [9], wherein the at least one processor is further configured to execute the computer-executable instructions to execute the SCC for the UE by: transmitting, by the serving DU, a downlink MAC Control Element (DL MAC CE) which includes the RACH preamble received from the target DU to the UE.

Item [15]. The apparatus according to item [14], wherein the target DU is configured to estimate a timing advance (TA) of the UE based on the preamble signal received from the UE, wherein the DL MAC CE includes the estimated TA.

Item [16]. An apparatus for configuring inter-cell changes, the apparatus comprising: at least one memory storing computer-executable instructions; and at least one processor configured to execute the computer-executable instructions to: receive, by a serving distributed unit (DU), a Random Access Channel (RACH) preamble, wherein the RACH preamble originates from a target distributed unit (DU); and execute, by the serving DU, a serving cell change (SCC) for a user equipment (UE) to one of a prepared target cell based on the RACH preamble; wherein the (UE) is not configured to perform uplink sync by the serving DU and the UE is not configured with a CFRA RACH preamble by the target DU, wherein the target DU is configured to determine whether availability of a RACH resource is subject to change between target cell configuration preparation and execution of the serving cell change; and wherein based on a determination that the RACH resource has become available, the target DU is configured to allocate a RACH preamble and send the RACH preamble to the serving DU, to configure contention free random access (CFRA) for the UE with a best beam group (BG) for the UE.

Item [17] The apparatus according to item [16], wherein the RACH preamble is received when a resource situation changes at the target DU.

Item [18]. The apparatus according to any one of items [15]-[16], executing the SCC comprises sending the RACH preamble to the UE via a downlink MAC Control Element (DL MAC CE).

Item [19]. The apparatus according to item [18], wherein the target DU is configured to estimate a timing advance (TA), and the DL MAC CE includes the estimated TA.

Item [20] The apparatus according to any one of items [17]-[19], wherein the RACH preamble is sent to the serving DU via a control unit (CU) or directly over a DU-DU interface.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method, performed by at least one processor, for configuring inter-cell changes, the method comprising:
transmitting, by a serving distributed unit (DU) to a user equipment (UE), a request to perform an uplink sync with a target cell of a target distributed unit (DU), wherein the UE performs the uplink sync with the target DU including transmitting a preamble signal to the target DU upon receiving the request, wherein the target DU determines a best beam group (BG) for the UE upon receiving the preamble signal;
receiving, by the serving DU, a Random Access Channel (RACH) preamble based on the best BG for the UE, wherein the RACH preamble originates from the target DU; and
executing, by the serving DU, a serving cell change (SCC) for the UE to one of a prepared target cell based on the received RACH preamble.

2. The method as claimed in claim 1, wherein the preamble signal used during the UL sync includes a contention based random access (CBRA) preamble, wherein the UE is configured to determine whether the uplink sync is successful or not,
wherein based on a determination that the uplink sync is successful, the target DU is configured to determine that there is no preamble allocated to the UE during a handover (HO) preparation phase, and
wherein based on a determination that there is no preamble allocated to the UE, the target DU is configured to allocate a RACH preamble and send to the UE via the serving DU, to configure contention free random access (CFRA) for the UE with the best BG for the UE.

3. The method as claimed in claim 1, wherein:
the preamble signal used during the UL sync includes a contention based random access (CBRA) preamble;
the UE is configured to determine whether the uplink sync is successful or not; and
based on a determination that the uplink sync is not successful, the UE is configured to prevent any further attempts of uplink sync.

4. The method as claimed in claim 3, wherein the UE is configured to determine whether the RACH preamble received from the serving DU has arrived at the UE or not prior to the serving DU executing the SCC, and
wherein based on a determination that an RACH preamble has not arrived at the serving DU prior to executing the SCC, the UE is configured to perform CBRA during execution of the SCC by the serving DU.

5. The method as claimed in claim 1, wherein the preamble signal includes a contention free random access (CFRA) preamble, wherein the target DU is configured to determine whether there is already a preamble allocated to the UE,
wherein based on a determination that there is already a preamble allocated to the UE, the target DU is configured to determine whether the preamble allocated to the UE is associated with the best BG for the UE, and
wherein based on a determination that the preamble allocated to the UE is not associated with the best BG for the UE, the target DU is configured to allocate the RACH preamble to be a new preamble associated with the best BG for the UE, and wherein the method further comprises:
sending the newly allocated RACH preamble to the serving DU,
wherein the sending to the serving DU is via a control unit (CU) or directly over a DU-DU interface.

6. The method as claimed in claim 1, wherein the serving DU executing the SCC for the UE further comprises:
transmitting, by the serving DU, a downlink MAC Control Element (DL MAC CE) which includes the RACH preamble received from the target DU to the UE.

7. The method as claimed in claim 6, wherein the target DU is configured to estimate a timing advance (TA) of the UE based on the preamble signal received from the UE, shared with the serving DU and wherein the DL MAC CE sent by the serving DU to the UE includes the estimated TA.

8. A method, performed by at least one processor, for configuring inter-cell changes, the method comprising:
receiving, by a serving distributed unit (DU), a Random Access Channel (RACH) preamble, wherein the RACH preamble originates from a target distributed unit (DU); and
executing, by the serving DU, a serving cell change (SCC) for a user equipment (UE) to one of a prepared target cell based on the RACH preamble,
wherein the (UE) is not configured to perform uplink sync by the serving DU and the UE is not configured with a CFRA RACH preamble by the target DU,
wherein the target DU is configured to determine whether availability of a RACH resource is subject to change between target cell configuration preparation and execution of the serving cell change, and
wherein based on a determination that the RACH resource has become available, the target DU is configured to allocate a RACH preamble and send the RACH preamble to the serving DU, to configure contention free random access (CFRA) for the UE with a best beam group (BG) for the UE.

9. An apparatus for configuring inter-cell changes, the apparatus comprising:
at least one memory storing computer-executable instructions; and
at least one processor configured to execute the computer-executable instructions to:
transmit, by a serving distributed unit (DU) to a user equipment (UE), a request to perform an uplink sync with a target cell of a target distributed unit (DU), wherein the UE performs the uplink sync with the target DU including transmitting a preamble signal to the target DU upon receiving the request, wherein the target DU determines a best beam group (BG) for the UE upon receiving the preamble signal;
receive, by the serving DU, a Random Access Channel (RACH) preamble based on the best BG, wherein the RACH preamble originates from the target DU; and
execute, by the serving DU, a serving cell change (SCC) for the UE to one of a prepared target cell based on the RACH preamble.

10. The apparatus as claimed in claim 9, wherein the preamble signal used during the UL sync includes a contention based random access (CBRA) preamble, wherein the UE is configured to determine whether the uplink sync is successful or not,
wherein based on a determination that the uplink sync is successful, the target DU is configured to determine that there is no preamble allocated to the UE during a handover (HO) preparation phase, and
wherein based on a determination that there is no preamble allocated to the UE, the target DU is configured to allocate a RACH preamble and send to the serving DU, to configure contention free random access (CFRA) for the UE with the best BG for the UE.

11. The apparatus as claimed in claim 9, wherein:
the preamble signal used during the UL sync includes a contention based random access (CBRA) preamble;
the UE is configured to determine whether the uplink sync is successful or not; and
based on a determination that the uplink sync is not successful, the UE is configured to prevent any further attempts of uplink sync.

12. The apparatus as claimed in claim 11, wherein the UE is configured to determine whether the RACH preamble received from the serving DU has arrived at the UE or not prior to the serving DU executing the SCC, and
wherein based on a determination that an RACH preamble has not arrived at the serving DU prior to executing the SCC, the UE is configured to perform CBRA during execution of the SCC by the serving DU.

13. The apparatus as claimed in claim 9, wherein the preamble signal includes a contention free random access (CFRA) preamble, wherein the target DU is configured to determine whether there is already a preamble allocated to the UE,
wherein based on a determination that there is already a preamble allocated to the UE, the target DU is configured to determine whether the preamble allocated to the UE is associated with the best BG for the UE, and
wherein based on a determination that the preamble allocated to the UE is not associated with the best BG for the UE, the target DU is configured to allocate the RACH preamble to be a new preamble associated with the best BG for the UE, and wherein the at least one processor is further configured to execute the computer-executable instructions to:
send the newly allocated RACH preamble to the serving DU,
wherein the sending to the serving DU is via a control unit (CU) or directly over a DU-DU interface.

14. The apparatus as claimed in claim 9, wherein the at least one processor is further configured to execute the computer-executable instructions to execute the SCC for the UE by:
transmitting, by the serving DU, a downlink MAC Control Element (DL MAC CE) which includes the RACH preamble received from the target DU to the UE.

15. The apparatus as claimed in claim 14, wherein the target DU is configured to estimate a timing advance (TA) of the UE based on the preamble signal received from the UE, wherein the DL MAC CE includes the estimated TA.

16. An apparatus for configuring inter-cell changes, the apparatus comprising:
at least one memory storing computer-executable instructions; and
at least one processor configured to execute the computer-executable instructions to:
receive, by a serving distributed unit (DU), a Random Access Channel (RACH) preamble, wherein the RACH preamble originates from a target distributed unit (DU); and
execute, by the serving DU, a serving cell change (SCC) for a user equipment (UE) to one of a prepared target cell based on the RACH preamble,
wherein the (UE) is not configured to perform uplink sync by the serving DU and the UE is not configured with a CFRA RACH preamble by the target DU,
wherein the target DU is configured to determine whether availability of a RACH resource is subject to change between target cell configuration preparation and execution of the serving cell change, and
wherein based on a determination that the RACH resource has become available, the target DU is configured to allocate a RACH preamble and send the RACH preamble to the serving DU, to configure contention free random access (CFRA) for the UE with a best beam group (BG) for the UE.

17. The apparatus as claimed in claim 16, wherein the RACH preamble is received when a resource situation changes at the target DU.

18. The apparatus as claimed in claim 16, wherein executing the SCC comprises sending the RACH preamble to the UE via a downlink MAC Control Element (DL MAC CE).

19. The apparatus as claimed in claim 18, wherein the target DU is configured to estimate a timing advance (TA), and the DL MAC CE includes the estimated TA.

20. The apparatus as claimed in claim 16, wherein the RACH preamble is sent to the serving DU via a control unit (CU) or directly over a DU-DU interface.
